(19) United States
(12) Patent Application Publication
(10) Pub. No.: US 2015/0286783 A1
(43) Pub. Date: Oct. 8, 2015

(54) PEER GROUP DISCOVERY FOR ANOMALY DETECTION

(71) Applicant: PALO ALTO RESEARCH CENTER INCORPORATED, Palo Alto, CA (US)

(72) Inventors: Sricharan Kallur Palli Kumar, Mountain View, CA (US); Juan J. Liu, Milpitas, CA (US)

(73) Assignee: PALO ALTO RESEARCH CENTER INCORPORATED, Palo Alto, CA (US)

(21) Appl. No.: 14/243,498

(22) Filed: Apr. 2, 2014

(51) Int. Cl. G06F 19/00

(52) U.S. Cl. CPC G06F 19/328; G06F 19/322

(57) ABSTRACT

One embodiment of the present invention provides a system for detecting anomalies. During operation, the system extracts from a data set of entities features which provide meaningful information about the entities. The system identifies a peer group for the entities in the data set based on auxiliary information which comprises information that is distinct from the extracted features. In order to determine the anomalies, the system compares the extracted features of an entity in the peer group against the extracted features of other entities in the corresponding peer group, where significant differences in results of the comparison are indicative of anomalies.

### BACKGROUND

1. Field

This disclosure is generally related to the detection of anomalies. More specifically, this disclosure is related to identifying peer groups to compare individuals to its peers rather than the general population, to ensure fair comparison for improved anomaly detection performance.

2. Related Art

Anomaly detection is the identification of items, events, or observations which do not conform to an expected pattern or other items in a data set. Anomaly detection usually encompasses the automatic or semi-automatic analysis of large quantities of data to identify previously unknown interesting patterns, including unusual records, e.g., anomalies. Typically the anomalous items will translate into a type of problem such as bank fraud, a structural defect, medical problems, or finding errors in text. Anomalies are also referred to as outliers.

Traditional anomaly detection methods involve extracting features from the raw data, and comparing data points based on these extracted features to identify outliers. Comparison of data points usually involves a form of logical distance measure that quantitatively describes how different two samples are from each other. Thus, data points that are “far away” from the general population are flagged as anomalies. However, these methods are less reliable if the data being analyzed is clustered in nature. The data points which belong to smaller clusters would be considered different compared to the rest of the data (the general population), and would therefore be marked incorrectly as anomalous points.

### SUMMARY

One embodiment of the present invention provides a system for detecting anomalies. During operation, the system extracts from a data set of entities features which provide meaningful information about the entities. The system identifies a peer group for the entities in the data set based on auxiliary information which comprises information that is distinct from the extracted features. In order to determine the anomalies, the system compares the extracted features of an entity in the peer group against the extracted features of other entities in the corresponding peer group, where significant differences in results of the comparison are indicative of anomalies.

One embodiment provides a system for identifying a peer group. During operation, the system determines a target entity within the data set of entities on which to detect an anomaly. An individual profile is created for each entity in the data set, including the target entity. This individual profile is based on auxiliary information which is distinct from the extracted features. The system then determines a similarity metric between the individual profile of the target entity and the individual profile of each entity in the data set, and further identifies a sub-set of entities from the data set where the determined similarity metric between the individual profile of the target entity and the individual profile of each entity in the data set is sufficiently small. The sub-set of entities comprises the peer group for the target entity.

In another embodiment, the distance between the individual profile of the target entity and the individual profile of each entity in the data set is measured using a weighted Euclidean distance measure within the feature space based on Term Frequency-Inverse Document Frequency (TF-IDF). The term in this distance measure is associated with an attribute of the entity and the weight for each term is set to be inversely proportional to the logarithm of the frequency of occurrence of the term in the data set.

In some embodiments, the data set of entities is associated with medical claims, and the extracted features comprise information relating to the medical claims. During operation, the system identifies a peer group for the entitites associated with the medical claims. This peer group comprises a group of entities that is a subset of the entities associated with the medical claims. Anomalies are determined by comparing the extracted features of an entity in the peer group against the extracted features of other entities in the corresponding peer group, wherein the anomalies are used to detect fraud, waste, and/or abuse within the medical claims data set.

In some embodiments, the entity associated with the medical claims is one or more of: a doctor; a pharmacy; and a patient.

Another embodiment provides a system for identifying a peer group for the entities associated with the medical claims. During operation, the system determines a target entity associated with the medical claims on which to detect anomalies. An individual profile is created for each entity associated with the medical claims, including the target entity. This individual profile is based on auxiliary information which is distinct from the extracted features. The system then determines a similarity metric between the individual profile of the target entity associated with the medical claims and the individual profile of each entity associated with the medical claims in the data set. The system identifies a sub-set of entities associated with the medical claims where the determined similarity metric between the individual profile of the target entity and the individual profile of each entity associated with the medical claims in the data set is sufficiently small. The sub-set of entities comprises the peer group for the target entity.

In another embodiment, the determined similar metric between the individual profile of the target entity and the individual profile of each entity associated with the medical claims in the data set is measured using a weighted Euclidean distance measure within the feature space based on Term Frequency-Inverse Document Frequency (TF-IDF), where the term corresponds to a medical procedure or a pharmacological prescription, and the weight for each term is set to be inversely proportional to the logarithm of the frequency of occurrence of the term in the data set of entities associated with the medical claims.

In some embodiments, the term used in the Term Frequency-Inverse Document Frequency (TF-IDF) distance measure can be associated with one or more of: a medical procedure; a specific type of medical procedure; a prescription for medication; a specific category of prescriptions for medication; and any attribute of a medical claim that indicates or distinguishes behavior of an entity associated with the medical claims on which to detect anomalies.

In some embodiments, the individual profile of an entity associated with the medical claims comprises one or more of: a procedure profile or a procedure dispense profile, which is based on how many different procedures the doctor has performed and the number of times the doctor has performed each of these procedures; and a prescription profile or a prescription dispense profile, which is based on how many prescriptions the entity has prescribed and the number of times the entity has prescribed each of the prescriptions.

### BRIEF DESCRIPTION OF THE FIGURES

FIG. 1 illustrates an exemplary framework that facilitates anomaly detection (prior art).

FIG. 2 illustrates an exemplary framework that facilitates anomaly detection, in accordance with an embodiment of the present invention.

FIG. 3 presents a flow chart illustrating a method for detecting anomalies, in accordance with an embodiment of the present invention.

FIG. 4 presents a flow chart illustrating a method for identifying a peer group, in accordance with an embodiment of the present invention.

FIG. 5 presents a flow chart illustrating a method for detecting anomalies within a dataset of medical claims, in accordance with an embodiment of the present invention.

FIG. 6 presents a flow chart illustrating a method for identifying a peer group of entities associated with medical claims, in accordance with an embodiment of the present invention.

FIG. 7 illustrates an exemplary computer system that facilitates detecting anomalies in accordance with an embodiment of the present invention.

In the figures, like reference numerals refer to the same figure elements.

### DETAILED DESCRIPTION

The following description is presented to enable any person skilled in the art to make and use the embodiments, and is provided in the context of a particular application and its requirements. Various modifications to the disclosed embodiments will be readily apparent to those skilled in the art, and the general principles defined herein may be applied to other embodiments and applications without departing from the spirit and scope of the present disclosure. Thus, the present invention is not limited to the embodiments shown, but is to be accorded the widest scope consistent with the principles and features disclosed herein.

### Overview

Embodiments of the present invention provide a system for detecting anomalies that solve the problem of inaccurately identified anomalies due to clustered data by using a data-driven method to accurately identify peers from the data set. This method of identifying or discovering a peer group is used as part of a system for detecting anomalies. Given a data set of entities on which to detect anomalies, the system extracts from the data set of entities features which provide meaningful information about the entities. The system also identifies a peer group for the entities in the data set based on auxiliary information, which can be separate from the extracted features. In other words, the auxiliary information comprises features which are used to help group certain entities together, e.g., to identify or discover the peer group.

Once the meaningful features have been extracted and the peer group has been identified based on the auxiliary information, the system compares the extracted features of an entity in the peer group against the extracted features of other entities in the same peer group. Any significant differences in the results of the comparison are indicative of anomalies. This method can thus account for data which is clustered in nature. By comparing an entity with its peer group as opposed to the general population, the system avoids the problem of incorrectly identifying entities, including those belonging to small clusters, as anomalies.

An exemplary embodiment of the present invention is described in the context of detecting anomalies within a data set of medical claims, where peers are selected based on the behavior exhibited by the providers. In the examples presented in this disclosure, these providers are doctors, but the same methodology can be applied to discovering peer groups among other entities, including pharmacies, patients, hospitals, and medical corporations. In the context of medical claims, the anomaly detection method can be used to uncover fraud, waste, and abuse within the system.

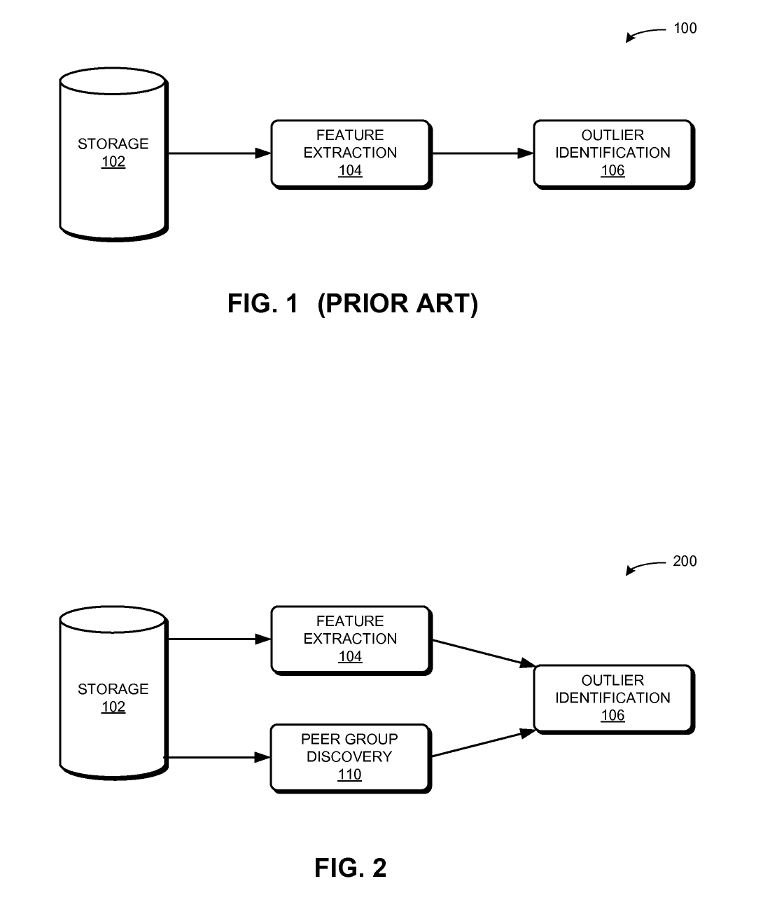

FIG. 1 illustrates a prior art framework 100 for detecting anomalies. Raw data is stored as a data set of entities in a storage 102. Features are extracted from the data set of entities in a feature extraction module 104. Entities are then compared to each other based on their extracted features in an outlier identification module 106. More specifically, the extracted features of an entity in the data set are compared with the extracted features of another entity in the general population of the data set. Outlier identification module 106 takes the results of this comparison and determine a similarity metric between these data points (the Euclidean distance between the extracted features of an entity in the data set and the extracted features of other entities in the general population).

Comparison of these data points is typically based on a form of distance measure, or a similarity metric, that quantitatively describes how far two data points are from each other. Data points which are far away from the general population are thus flagged as anomalies. This prior art method for identifying outliers can be unreliable if the data being analyzed is clustered in nature because the data points which belong to smaller clusters would be considered different compared to the rest of the general population. Thus, in these instances, the prior art framework could inaccurately identify anomalies within the system.

FIG. 2 illustrates a framework 200 for detecting anomalies, in accordance with an embodiment of the present invention. Raw data is stored as a data set of entities in storage 102. A feature extraction module 104 extracts features from the data set of entities. Before outlier identification 106 occurs, the system performs a peer group discovery process 110, and identifies a peer group for the entities in the data set based on auxiliary information. This auxiliary information can be distinct from the extracted features. Peer group discovery 110 occurs before outlier identification 106. In other words, before performing anomaly detection, similar groups of data points that constitute individual clusters are discovered. In this disclosure, these similar groups are referred to as peer groups.

During outlier identification process 106, the system compares the extracted features of an entity in the peer group against the extracted features of other entities in the corresponding peer group. Even if the data being analyzed is clustered in nature, framework 200 accounts for such data because data points are only compared to other data points from the same peer group, rather than to data points from the general population.

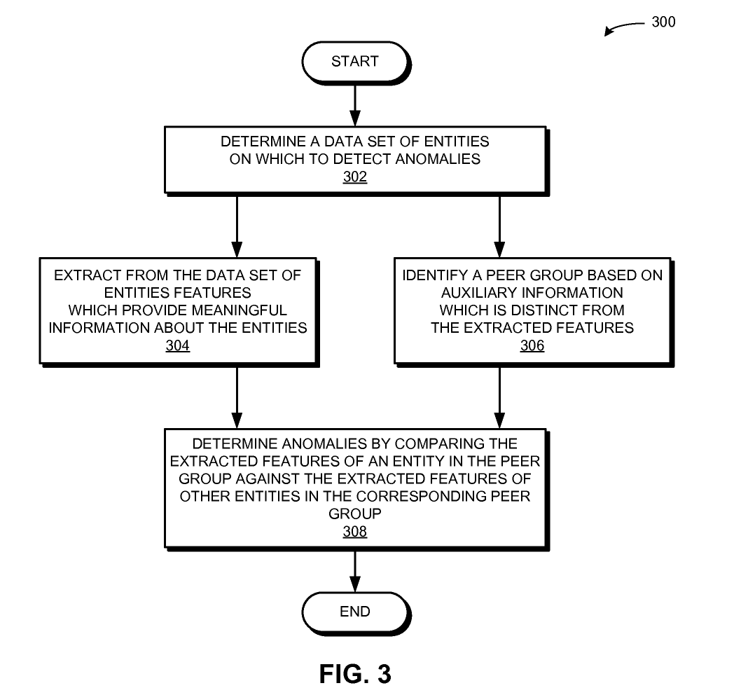

FIG. 3 presents a flow chart 300 illustrating a method for detecting anomalies, in accordance with an embodiment of the present invention. During operation, the system determines a data set of entities on which to detect anomalies (operation 302). Assume that raw data exists as entities of a data set on which to detect anomalies, and that these entities are stored in some type of storage medium or device. The system then extracts from the data set features which provide meaningful information about the entities (operation 304). The system also identifies a peer group based on auxiliary information which is distinct from the extracted features (operation 306). The system uses this distinct, auxiliary information in a data-driven method to accurately identify the peers of an entity from the entities of the data set.

Subsequently, the system determines anomalies by comparing the extracted features of an entity in the peer group against the extracted features of other entities in the corresponding peer group (operation 308). Significant differences in the results of the comparison indicate anomalies. In this way, the outlier identification takes into account both the extracted features and the peer group discovered using auxiliary information. More importantly, the outlier identification compares a data point with other similar data points (in its peer group), rather than with the general population, thus avoiding the inaccuracies encountered by the traditional anomaly detection framework shown in FIG. 1.

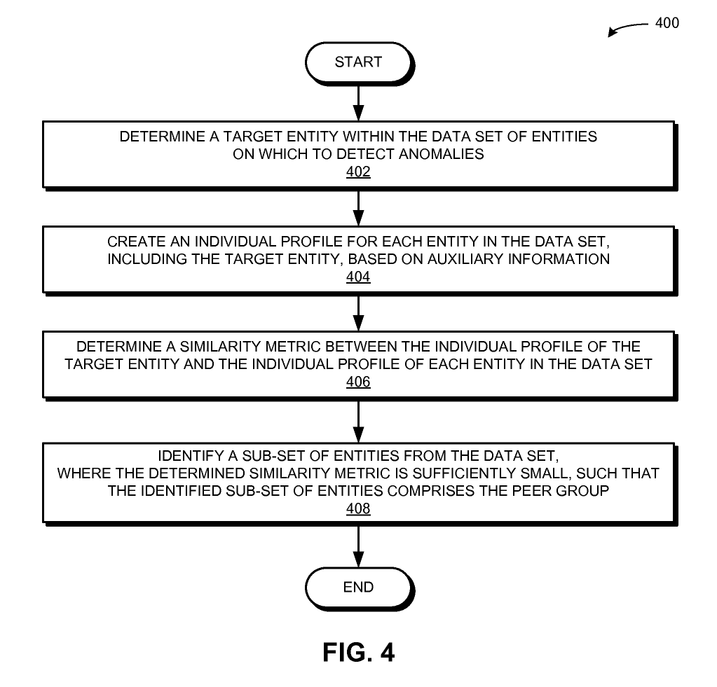

FIG. 4 presents a flow chart 400 illustrating a method for identifying a peer group, in accordance with an embodiment of the present invention. During operation, to discover the peer group, the system determines a target entity within the data set of entities on which to detect anomalies (operation 402). The system then creates an individual profile for each entity in the data set, including the target entity, based on the auxiliary information (operation 404). Next, the system determines a similarity metric between the individual profile of the target entity and the individual profile of each entity in the data set (operation 406). This similarity metric is a quantitative description of how far two data points are from each other. Based on the determined similarity metric between the individual profile of the target entity and the individual profile of each entity in the data set, a sub-set of entities is then identified where the determined similarity metric is sufficiently small (operation 408). In other words, when two data points are considered similar or “close” to one another, they are considered to belong to the same peer group. Furthermore, all data points which are similar or close to each other, e.g., where the determined similarity metric between them is sufficiently small, are considered to belong to the same peer group. In this manner, a peer group for the target entity is identified.

### Anomaly Detection in Medical Claims

An exemplary embodiment of the present invention is described in the context of detecting anomalies within a data set of medical claims, where the medical claims are each associated with one or more medical providers. In this example, peers are selected based on the behavior exhibited by the medical providers. The medical providers described in this embodiment are doctors, but the same methodology can be applied to discovering peer groups among other entities, including patients, pharmacies, hospitals, and medical corporations. Furthermore, in the context of medical claims, the anomaly detection is for the purpose of uncovering fraud, waste, and abuse within the system.

Instances of fraud, waste and abuse are currently detected in medical claims via rules specified by medical domain experts. As shown in embodiments of the present invention, in order to accurately assess whether the behavior or actions of a particular medical provider is fraudulent (e.g., the treatment procedures applied by a cardiologist), it is critical that the doctor's behavior be contrasted only against his peers (e.g., other cardiologists), and not against the general population of all medical providers. In other words, a framework is used which employs filtered population statistics (e.g., peer group discovery) to ensure a fair comparison, thus resulting in improved accuracy in anomaly detection (or, as in the case of medical claims, detection of fraud, waste, and abuse).

In a medical claims data set, doctors associated with the medical claims are designated with specialty codes that can be used to identify their peers. Likewise, pharmacies are tagged by the dispensing service they provide (e.g., compounding pharmacies, Durable Medical Equipment (DME) pharmacies, etc.) and the ownership type (e.g., Independent, Government owned, franchise, etc.). However, despite the use of these specialty codes and tags within the medical claims, in reality, the designations themselves may prove unreliable. For example, the behavior of a cardiologist who only tends to children (pediatric cardiologist) could differ significantly from cardiologists who tend to adults. As a result, the behavior of the pediatric cardiologist might seem suspicious and fraudulent when compared against a population of general cardiologists. In this situation, using the codes to detect anomalies would result in the pediatric cardiologist being compared with the general cardiologist population, and thus subsequently being erroneously tagged for suspicious behavior.

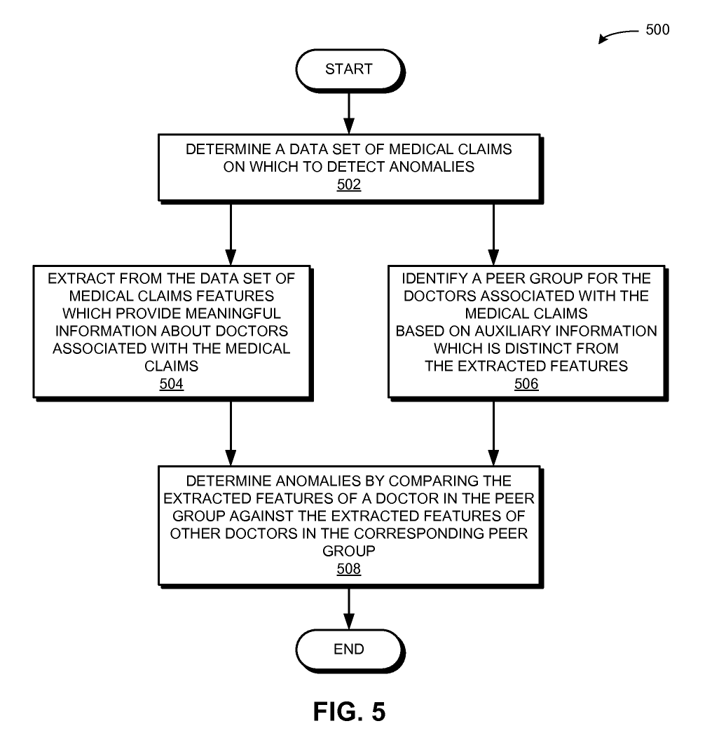

FIG. 5 presents a flow chart illustrating a method 500 for detecting anomalies within a dataset of medical claims. During operation, a data set of medical claims on which to detect anomalies is determined (operation 502). Assume that the medical claims are represented as entities, and that this data set of entities is stored in some type of storage medium or device. The system extracts from the data set features which provide meaningful information about doctors associated with the medical claims (operation 504). These extracted features can include, for example, the number of narcotics prescribed and the number of surgeries performed. These extracted features are sometimes called anomaly features, referring to a set of features designed to track anomalous behavior.

The system also identifies a peer group for the doctors associated with the medical claims, based on auxiliary information which is distinct from the extracted features (operation 506). The system uses this distinct, auxiliary information in a data-driven method to accurately identify the peers of a doctor from the doctors associated with medical claims of the data set. The auxiliary information can include, for example, how many different procedures a doctor has performed and the number of times he has performed each of these procedures. If the target medical provider or entity was a pharmacy, the auxiliary information could include, for example, how many prescriptions a pharmacy has prescribed and the number of times the entity has prescribed each of the prescriptions.

The system determines anomalies by comparing the extracted features of a doctor in the peer group against the extracted features of other doctors in the corresponding peer group (operation 508). Significant differences in the results of the comparison indicate anomalies. In this way, the outlier identification takes into account both the extracted features of the doctor and the doctor's peer group discovered using auxiliary information. More importantly, the outlier identification compares a doctor to other similar doctors (peer group), rather than to the general population of doctors, thus avoiding the inaccuracies encountered by the traditional anomaly detection framework shown in FIG. 1.

By way of example, assume that the doctor of interest (or target doctor) works in a pain clinic and that the extracted meaningful features include information on the number of narcotics prescribed. Such a doctor would necessarily prescribe a large number of narcotics to his patients in the course of his regular work. Under the traditional anomaly detection framework shown in FIG. 1, if this target doctor is compared against the general population of all other doctors, then the number of narcotics prescribed by this doctor would seem suspicious and would thus be flagged as anomalies. In contrast, using the anomaly detection method 500 depicted in FIG. 5, the peer group of the target doctor would have been discovered and identified as other doctors who work in pain clinics. For example, auxiliary information such as how many different examinations or procedures a doctor has performed and the number of times he has performed each of these examinations or procedures could be used to identify the doctor's peer group. This auxiliary information is distinct from the extracted features. The extracted features of the target doctor (number of narcotics prescribed) would then be compared against the same extracted features of the target doctor's peer group, e.g., other doctors who also work in pain clinics. The doctors in the target doctor's peer group most likely prescribe a close (or rather, an insignificantly different) number of narcotics as compared to the target doctor. In other words, the values of the extracted features are likely similar. This ensures that the anomalies are not incorrectly identified and that the target doctor is not incorrectly flagged for suspicious behavior, thus improving the accuracy of the anomaly detection performance.

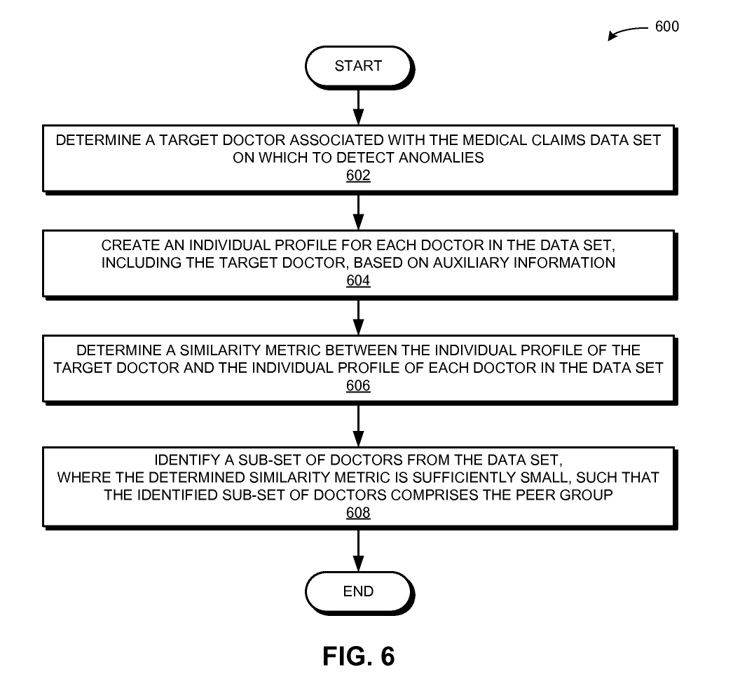

FIG. 6 presents a flow chart 600 illustrating a method for identifying a peer group of doctors associated with medical claims, in accordance with an embodiment of the present invention. During operation, in order to discover the peer group, the system determines a target doctor associated with the medical claims data set on which to detect anomalies (operation 602). The system creates an individual profile for each doctor associated with the medical claims in the data set, including the target doctor, based on the auxiliary information (operation 604). The profile of a doctor contains information on, for example, how many different procedures he has performed, and the number of times he has performed each of these procedures. Based on this definition of a doctor's individual profile, two doctors are deemed similar (or close) if they have both performed a similar set of procedures and the number of times they have performed each of the individual procedures is also similar. In this context, the individual profile can be referred to as the procedure profile or the procedure dispense profile.

Next, the system determines a similarity metric between the individual profile of the target doctor and the individual profile of each doctor in the data set (operation 606). This similarity metric is a quantitative description of how far two data points are from each other. Assume that the data set of medical claims contains N doctors: d₁, d_{N}, and that there are M distinct procedures: p₁, . . . , p_{M}. Also assume that the number of times procedure pⱼ is performed by doctor dᵢ is given by cᵢⱼ. The procedure dispense profile of an individual doctor dᵢ is thus defined as Cᵢ=[cᵢ₁, cᵢ₂, . . . c_{iM}]. The similarity metric uses the procedure profiles Cᵢ to determine which doctors are similar to each other.

Upon determining the similarity metric between the individual profile of the target doctor and the individual profile of each doctor in the data set (operation 606), the system identifies a sub-set of doctors from the data set, where the determined similarity metric is sufficiently small (operation 608). This sub-set of doctors comprises the peer group of the target doctor. In terms of the variables defined above, the system identifies peers of a target doctor dᵢ by identifying doctors whose procedure profiles are close to the procedure profile Cᵢ of the target doctor dᵢ.

Term Frequency-Inverse Document Frequency in Medical Claims Example

One important factor which affects the accuracy of the identified peer group is that the individual procedure profiles of the doctors are dominated by generic procedures such as X-rays, checking blood pressure and temperature, etc. These generic procedures are commonly used by almost all doctors. As a result, some methods of distance measure result in grouping all the doctors as being similar to each other. This problem is commonly referred to as down-weighting generic procedures, and is identical to a problem in document similarity literature. In that context, the problem is identifying similar documents in a corpus of documents based on the words that appear in the document while de-emphasizing the influence of generic words, e.g., “and”, “or”, “the”, and “that.” One approach to address this problem is to use a weighted Euclidean distance measure, where the weights for each word dimension are set to be inversely proportional to the logarithm of the frequency of occurrence of the word in the entire database. This approach is commonly referred to as Term Frequency-Inverse Document Frequency (TF-IDF).

In one embodiment of the present invention, the system uses the Term Frequency-Inverse Document Frequency (TF-IDF) approach, where the doctors assume the role of the documents, and the procedures performed by the doctors assume the role of the words in the document. In this context, the term corresponds to a medical procedure, and the weight for each term is set to be inversely proportional to the logarithm of the frequency of occurrence of the term in the data set of doctors associated with the medical claims. The term here could also correspond to a pharmacological prescription, a specific category of prescriptions for medicine, a specific type of medical procedure, or any attribute of a medical claim that indicates or distinguishes the behavior of a doctor or another entity associated with the medical claims on which to detect anomalies.

The Term Frequency (TF) vector of the present invention is given by the procedure profiles C₁. As mentioned above, the procedure dispense profile of individual doctor dᵢ is defined as Cᵢ=[cᵢ₁, cᵢ₂, . . . , c_{iM}], where the number of times procedure pⱼ is performed by doctor dᵢ is given by cᵢⱼ. The Inverse Document Frequency (IDF) Iⱼ of a procedure pⱼ is given by:

Iⱼ=log(N/|dᵢ in D:cᵢⱼ>0|),

where the numerator N within the logarithm is the total number of doctors, and the denominator is the number of doctors who have performed procedure pⱼ at least once. Thus, the IDF term weighs in the uniqueness of the procedure as a metric of semantic importance.

The weighted Euclidean distance measure W_{E} in terms of the TF-IDF is then given by:

W_{E}(Cₐ, C_{b})=Σ^{M}ⱼ₌₁ Iⱼ(cₐⱼ−c_{bj})².

Using this measure, the peers of a doctor dₐ are given by:

Peers(dₐ)={d_{b}:W_{E}(Cₐ, C_{b}) is small}.

### TF-IDF in General Anomaly Detection Framework

In accordance with another embodiment of the present invention, where the data set of entities, or objects, is not specified as any particular type, measuring the distance uses a weighted Euclidean distance measure based on Term Frequency-Inverse Document Frequency (TF-IDF), where the term is associated with an attribute of an object and the weight for each term is set to be inversely proportional to the logarithm of the frequency of occurrence of the term in the data set. Assume that the data set of objects contains N objects: O₁, . . . , O_{N}, and that there are M distinct attributes: p₁, . . . , p_{M}. Also assume that the number of times attribute pⱼ occurs for object Oᵢ is given by cᵢⱼ. The individual profile of an object Oᵢ is thus defined as Cᵢ=[cᵢ₁, cᵢ₂, . . . , cᵢₘ]. The quantitative method to measure the distance uses the individual profiles Cᵢ to determine which objects are similar to each other.

The system uses the Term Frequency-Inverse Document Frequency (TF-IDF) approach to measure the distance between individual profiles Cᵢ, where the objects assume the role of the documents, and the attributes of the objects assume the role of the words in the document. In other words, the term is associated with an attribute of an object and the weight for each term is inversely proportional to the logarithm of the frequency of occurrence of the term in the data set. The Term Frequency (TF) vector of the present example is given by the individual profiles Cᵢ. The Inverse Document Frequency (IDF) Iⱼ of an attribute pⱼ is given by:

Iⱼ=log(N/|dᵢ in D:cᵢⱼ>0|),

where the numerator N within the logarithm is the total number of objects, and the denominator is the number of objects that contain the attribute pⱼ at least once. Thus, the IDF term weighs in the uniqueness of the attribute as a metric of semantic importance.

The weighted Euclidean distance measure W_{E} in terms of the TF-IDF is then given by:

W_{E}(Cₐ, C_{b})=Σ^{M}ⱼ₌₁ Iⱼ(cₐⱼ−c_{bj})².

Using this measure, the peers of an object Oₐ are given by:

Peers(Oₐ)={O_{b}:W_{E}(Cₐ, C_{b}) is small}.

### Apparatus and Computer System

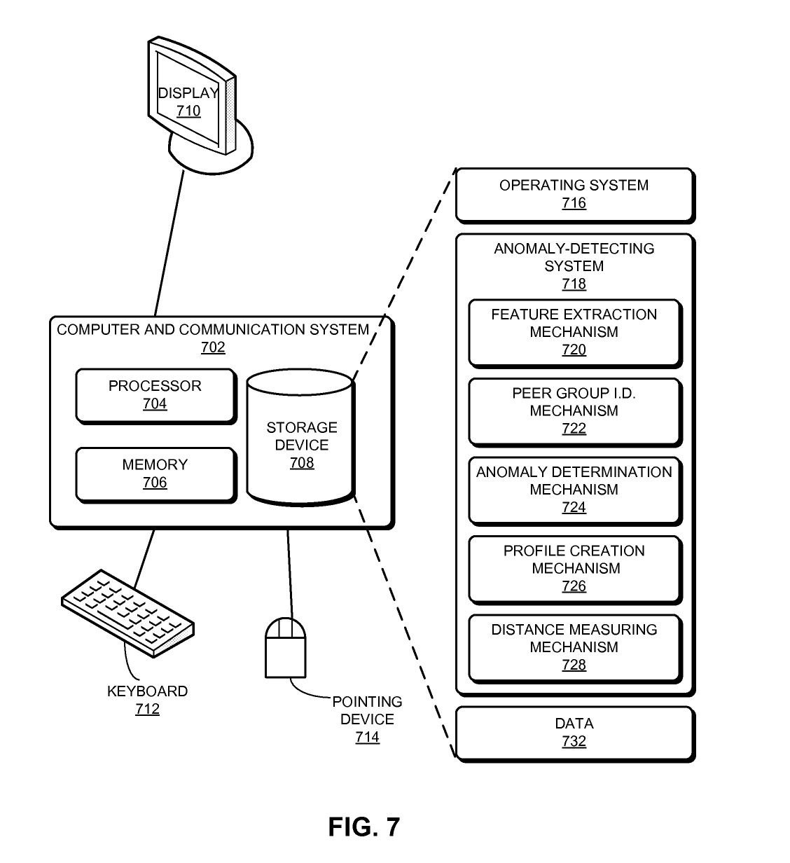

FIG. 7 illustrates an exemplary computer and communication system 702 that facilitates detecting anomalies using peer groups, in accordance with an embodiment of the present invention. Computer and communication system 702 includes a processor 704, a memory 706, and a storage device 708. Memory 706 can include a volatile memory (e.g., RAM) that serves as a managed memory, and can be used to store one or more memory pools. Furthermore, computer and communication system 702 can be coupled to a display device 710, a keyboard 712, and a pointing device 714. Storage device 708 can store an operating system 716, an anomaly-detecting system 718, and data 732.

Anomaly-detecting system 718 can include instructions, which when executed by computer and communication system 702, can cause computer and communication system 702 to perform methods and/or processes described in this disclosure. Specifically, anomaly-detecting system 718 may include instructions for extracting from a data set of entities features which provide meaningful information about the entities (feature extraction mechanism 720). Anomaly-detecting system 718 can also include instructions for identifying a peer group for the entities in the data set based on auxiliary information, where the auxiliary information is distinct from the extracted features (peer group identification mechanism 722). Further, anomaly-detecting system 718 can include instructions for determining anomalies by comparing the extracted features of an entity in the peer group against the extracted features of other entities in the corresponding peer group, such that significant differences in results of the comparison would indicate anomalies (anomaly determination mechanism 724).

Anomaly-detecting system 718 can also include instructions for creating an individual profile for each entity in the data set, based on the distinct auxiliary information (profile creation mechanism 726). Anomaly-detecting system 718 can further include instructions for determining a similarity metric between the individual profile of a determined target entity and the individual profile of each entity in the data set (distance measuring mechanism 728). Anomaly-detecting system 718 can also include instructions for using specific methods, such as a weighted Euclidean distance measure within the feature space based on Term Frequency-Inverse Document Frequency (TF-IDF), to determine the similarity metric between the individual profile of a target entity and the individual profile of each entity in the data set (distance measuring mechanism 728).

Anomaly-detecting system 718 can further include instructions to determine a target entity within the data set of entities on which to detect anomalies (peer group identification mechanism 722). Peer group identification mechanism 722 can include instructions to communicate with profile creation mechanism 726 and distance measuring mechanism 728 in order to identify a subset of entities from the data set where the determined similarity metric between the individual profile of the target entity and the individual profile of each entity in the data set is sufficiently small, wherein the subset of entities comprises the peer group.

Data 732 can include any data that is required as input or that is generated as output by the methods and/or processes described in this disclosure. Specifically, data 732 can store at least: the data set of entities on which to detect anomalies; the extracted features of the entities in the data set which provide meaningful information about the entities; the auxiliary information, which is distinct from the extracted features, relating to the entities; the individual profiles for each entity in the data set based on the auxiliary information; the similarity metrics between individual profiles of the target entity and each entity in the data set; the identified peer group; and the anomalies identified from the original data set of entities.

The data structures and code described in this detailed description are typically stored on a computer-readable storage medium, which may be any device or medium that can store code and/or data for use by a computer system. The computer-readable storage medium includes, but is not limited to, volatile memory, non-volatile memory, magnetic and optical storage devices such as disk drives, magnetic tape, CDs (compact discs), DVDs (digital versatile discs or digital video discs), or other media capable of storing computer-readable media now known or later developed.

The methods and processes described in the detailed description section can be embodied as code and/or data, which can be stored in a computer-readable storage medium as described above. When a computer system reads and executes the code and/or data stored on the computer-readable storage medium, the computer system performs the methods and processes embodied as data structures and code and stored within the computer-readable storage medium.

Furthermore, the methods and processes described above can be included in hardware modules or apparatus. The hardware modules or apparatus can include, but are not limited to, application-specific integrated circuit (ASIC) chips, field-programmable gate arrays (FPGAs), dedicated or shared processors that execute a particular software module or a piece of code at a particular time, and other programmable-logic devices now known or later developed. When the hardware modules or apparatus are activated, they perform the methods and processes included within them.

The foregoing descriptions of embodiments of the present invention have been presented for purposes of illustration and description only. They are not intended to be exhaustive or to limit the present invention to the forms disclosed. Accordingly, many modifications and variations will be apparent to practitioners skilled in the art. Additionally, the above disclosure is not intended to limit the present invention. The scope of the present invention is defined by the appended claims.

What is claimed is:

1. A computer-implemented method for detecting anomalies, the method comprising:
extracting from a data set of entities features which provide meaningful information about the entities;
identifying a peer group for the entities in the data set based on auxiliary information which comprises information that is distinct from the extracted features; and
determining anomalies by comparing the extracted features of an entity in the peer group against the extracted features of other entities in the corresponding peer group, wherein significant differences in results of the comparison are indicative of anomalies.

2. The method of claim 1, wherein identifying a peer group further comprises:
determining a target entity within the data set of entities on which to detect anomalies;
creating an individual profile for each entity in the data set, including the target entity, based on the auxiliary information;
determining a similarity metric between the individual profile of the target entity and the individual profile of each entity in the data set; and
identifying a sub-set of entities from the data set wherein the determined similarity metric between the individual profile of the target entity and the individual profile of each entity in the data set is sufficiently small, wherein the sub-set of entities comprises the peer group.

3. The method of claim 2, wherein determining the similarity metric between the individual profile of the target entity and the individual profile of each entity in the data set further comprises:
using a weighted Euclidean distance measure within a feature space based on Term Frequency-Inverse Document Frequency (TF-IDF), where the term is associated with an attribute of the entity and the weight for each term is set to be inversely proportional to the logarithm of the frequency of occurrence of the term in the data set.

4. The method of claim 1, wherein:
the data set of entities is associated with medical claims;
the extracted features comprise information relating to the medical claims;
identifying a peer group for the entities associated with the medical claims comprises identifying a peer group of entities that is a subset of the entities associated with the medical claims; and
determining the anomalies further comprises comparing the extracted features of an entity in the peer group against the extracted features of other entities in the corresponding peer group, wherein the anomalies are used to detect fraud, waste, and/or abuse within the medical claims data set.

5. The method of claim 4, wherein the entity associated with the medical claims is further associated with one or more of:
a doctor;
a pharmacy; and
a patient.

6. The method of claim 5, wherein identifying a peer group further comprises:
determining a target entity associated with the medical claims on which to detect anomalies;
creating an individual profile for each entity associated with the medical claims, including the target entity, based on the auxiliary information;
determining a similarity metric between the individual profile of the target entity associated with the medical claims and the individual profile of each entity associated with the medical claims in the data set; and
identifying a sub-set of entities associated with the medical claims from the data set of medical claims wherein the determined similarity metric between the individual profile of the target entity and the individual profile of each entity associated with the medical claims in the data set is sufficiently small, wherein the sub-set of entities comprises the peer group.

7. The method of claim 6, wherein determining the similarity metric between the individual profile of the target entity and the individual profile of each entity associated with the medical claims further comprises:
using a weighted Euclidean distance measure within a feature space based on Term Frequency-Inverse Document Frequency (TF-IDF), where the term corresponds to a medical procedure or a pharmacological prescription, and the weight for each term is set to be inversely proportional to the logarithm of the frequency of occurrence of the term in the data set of doctors associated with the medical claims.

8. The method of claim 7, wherein the term used in the Term Frequency-Inverse Document Frequency (TF-IDF) distance measure is associated with one or more of:
a medical procedure;
a specific type of medical procedure;
a prescription for medication;
a specific category of prescriptions for medication; and
any attribute of a medical claim that indicates or distinguishes behavior of an entity associated with the medical claims on which to detect anomalies.

9. The method of claim 7, wherein the individual profile of an entity associated with the medical claims comprises one or more of:
a procedure profile or a procedure dispense profile, which is based on how many different procedures the entity has performed and the number of times the entity has performed each of these procedures; and
a prescription profile or a prescription dispense profile, which is based on how many prescriptions the entity has prescribed and the number of times the entity has prescribed each of the prescriptions.

10. A non-transitory computer-readable storage medium storing instructions that when executed by a computer cause the computer to perform a method, the method comprising:
extracting from a data set of entities features which provide meaningful information about the entities;
identifying a peer group for the entities in the data set based on auxiliary information which comprises information that is distinct from the extracted features; and
determining anomalies by comparing the extracted features of an entity in the peer group against the extracted features of other entities in the corresponding peer group, wherein significant differences in results of the comparison are indicative of anomalies.

11. The storage medium of claim 10, wherein identifying a peer group further comprises:
determining a target entity within the data set of entities on which to detect anomalies;
creating an individual profile for each entity in the data set, including the target entity, based on the auxiliary information;
determining a similarity metric between the individual profile of the target entity and the individual profile of each entity in the data set; and
identifying a sub-set of entities from the data set wherein the determined similarity metric between the individual profile of the target entity and the individual profile of each entity in the data set is sufficiently small, wherein the sub-set of entities comprises the peer group.

12. The storage medium of claim 11, wherein determining the similarity metric between the individual profile of the target entity and the individual profile of each entity in the data set further comprises:
using a weighted Euclidean distance measure within a feature space based on Term Frequency-Inverse Document Frequency (TF-IDF), where the term is associated with an attribute of the entity and the weight for each term is set to be inversely proportional to the logarithm of the frequency of occurrence of the term in the data set.

13. The storage medium of claim 10, wherein:
the data set of entities is associated with medical claims;
the extracted features comprise information relating to the medical claims;
identifying a peer group for the entities associated with the medical claims comprises identifying a peer group of entities that is a subset of the entities associated with the medical claims; and
determining the anomalies further comprises comparing the extracted features of an entity in the peer group against the extracted features of other entities in the corresponding peer group, wherein the anomalies are used to detect fraud, waste, and/or abuse within the medical claims data set.

14. The storage medium of claim 13, wherein the entity associated with the medical claims is further associated with one or more of:
a doctor;
a pharmacy; and
a patient.

15. The storage medium of claim 14, wherein identifying a peer group further comprises:
determining a target entity associated with the medical claims on which to detect anomalies;
creating an individual profile for each entity associated with the medical claims, including the target entity, based on the auxiliary information;
determining a similarity metric between the individual profile of the target entity associated with the medical claims and the individual profile of each entity associated with the medical claims in the data set; and
identifying a sub-set of entities associated with the medical claims from the data set of medical claims wherein the determined similarity metric between the individual profile of the target entity and the individual profile of each entity associated with the medical claims in the data set is sufficiently small, wherein the sub-set of entities comprises the peer group.

16. The storage medium of claim 15, wherein determining the similarity metric between the individual profile of the target entity and the individual profile of each entity associated with the medical claims further comprises:
using a weighted Euclidean distance measure with a feature space based on Term Frequency-Inverse Document Frequency (TF-IDF), where the term corresponds to a medical procedure or a pharmacological prescription, and the weight for each term is set to be inversely proportional to the logarithm of the frequency of occurrence of the term in the data set of doctors associated with the medical claims.

17. The storage medium of claim 16, wherein the term used in the Term Frequency-Inverse Document Frequency (TF-IDF) distance measure is associated with one or more of:
a medical procedure;
a specific type of medical procedure;
a prescription for medication;
a specific category of prescriptions for medication; and
any attribute of a medical claim that indicates or distinguishes behavior of an entity associated with the medical claims on which to detect anomalies.

18. The storage medium of claim 16, wherein the individual profile of an entity associated with the medical claims comprises one or more of:
a procedure profile or a procedure dispense profile, which is based on how many different procedures the entity has performed and the number of times the entity has performed each of these procedures; and
a prescription profile or a prescription dispense profile, which is based on how many prescriptions the entity has prescribed and the number of times the entity has prescribed each of the prescriptions.

19. A computer system to detect anomalies, comprising:
a processor;
a storage device coupled to the processor and storing instructions that when executed by a computer cause the computer to perform a method, the method comprising:
extracting from a data set of entities features which provide meaningful information about the entities;
identifying a peer group for the entities in the data set based on auxiliary information which comprises information that is distinct from the extracted features; and
determining anomalies by comparing the extracted features of an entity in the peer group against the extracted features of other entities in the corresponding peer group, wherein significant differences in results of the comparison are indicative of anomalies.

20. The computer system of claim 19, wherein identifying a peer group further comprises:
determining a target entity within the data set of entities on which to detect anomalies;
creating an individual profile for each entity in the data set, including the target entity, based on the auxiliary information;
determining a similarity metric between the individual profile of the target entity and the individual profile of each entity in the data set; and
identifying a sub-set of entities from the data set wherein the determined similarity metric between the individual profile of the target entity and the individual profile of each entity in the data set is sufficiently small, wherein the sub-set of entities comprises the peer group.

21. The computer system of claim 20, wherein determining the similarity metric between the individual profile of the target entity and the individual profile of each entity in the data set further comprises:
using a weighted Euclidean distance measure within a feature space based on Term Frequency-Inverse Document Frequency (TF-IDF), where the term is associated with an attribute of the entity and the weight for each term is set to be inversely proportional to the logarithm of the frequency of occurrence of the term in the data set.

22. The computer system of claim 19, wherein:
the data set of entities is associated with medical claims;
the extracted features comprise information relating to the medical claims;
identifying a peer group for the entities associated with the medical claims comprises identifying a peer group of entities that is a subset of the entities associated with the medical claims; and
determining the anomalies further comprises comparing the extracted features of an entity in the peer group against the extracted features of other entities in the corresponding peer group, wherein the anomalies are used to detect fraud, waste, and/or abuse within the medical claims data set.

23. The computer system of claim 22, wherein the entity associated with the medical claims is further associated with one or more of:
a doctor;
a pharmacy; and
a patient.

24. The computer system of claim 23, wherein identifying a peer group further comprises:
determining a target entity associated with the medical claims on which to detect anomalies;
creating an individual profile for each entity associated with the medical claims, including the target entity, based on the auxiliary information;
determining a similarity metric between the individual profile of the target entity associated with the medical claims and the individual profile of each entity associated with the medical claims in the data set; and
identifying a sub-set of entities associated with the medical claims from the data set of medical claims wherein the determined similarity metric between the individual profile of the target entity and the individual profile of each entity associated with the medical claims in the data set is sufficiently small, wherein the sub-set of entities comprises the peer group.

25. The computer system of claim 24, wherein determining the similarity metric between the individual profile of the target entity and the individual profile of each entity associated with the medical claims further comprises:
using a weighted Euclidean distance measure within a feature space based on Term Frequency-Inverse Document Frequency (TF-IDF), where the term corresponds to a medical procedure or a pharmacological prescription, and the weight for each term is set to be inversely proportional to the logarithm of the frequency of occurrence of the term in the data set of doctors associated with the medical claims.

26. The computer system of claim 25, wherein the term used in the Term Frequency-Inverse Document Frequency (TF-IDF) distance measure is associated with one or more of:
a medical procedure;
a specific type of medical procedure;
a prescription for medication;
a specific category of prescriptions for medication; and
any attribute of a medical claim that indicates or distinguishes behavior of an entity associated with the medical claims on which to detect anomalies.

27. The computer system of claim 25, wherein the individual profile of an entity associated with the medical claims comprises one or more of:
a procedure profile or a procedure dispense profile, which is based on how many different procedures the entity has performed and the number of times the entity has performed each of these procedures; and
a prescription profile or a prescription dispense profile, which is based on how many prescriptions the entity has prescribed and the number of times the entity has prescribed each of the prescriptions.
